(19) United States
(12) Patent Application Publication
(10) Pub. No.: US 2017/0158022 A1
(43) Pub. Date: Jun. 8, 2017

(54) HEAT PUMP SYSTEM FOR VEHICLE AND METHOD OF CONTROLLING THE SAME

(71) Applicant: Hyundai Motor Company, Seoul (KR)

(72) Inventor: Jae Yeon KIM, Hwaseong-si (KR)

(73) Assignee: Hyundai Motor Company, Seoul (KR)

(21) Appl. No.: 15/441,018

(22) Filed: Feb. 23, 2017

Related U.S. Application Data
(62) Division of application No. 14/986,162, filed on Dec. 31, 2015.
Application No. 14/986,162 is a division of application No. 13/706,111, filed on Dec. 5, 2012, now abandoned.

(30) Foreign Application Priority Data
Sep. 7, 2012 (KR) 10-2012-0099535

(51) Int. Cl. B60H 1/00; B60H 1/22; B60H 3/02; B60H 1/14

(52) U.S. Cl. CPC B60H 1/00921; B60H 1/143; B60H 1/2225; B60H 3/024; B60H 2001/00928; B60H 2001/00949

(57) ABSTRACT

A heat pump system for a vehicle may include a cooling apparatus that supplies and circulates coolant to a motor and an electrical equipment through a cooling line, wherein the cooling apparatus includes a radiator, a cooling fan that ventilates wind to the radiator, and a water pump connected to the cooling line, and an air conditioner apparatus connected through a refrigerant line, wherein the air conditioner apparatus includes a water-cooled condenser connected to the cooling line to change a temperature of the coolant using a waste heat that has occurred in the motor and the electrical equipment according to each mode of the vehicle and that is connected to the refrigerant line to enable an injected refrigerant in the refrigerant line to exchange a heat with the coolant at the inside thereof, and an air-cooled condenser connected in series to the water-cooled condenser through the refrigerant line.

### CROSS-REFERENCE TO RELATED APPLICATION

The present application claims priority to Korean Patent Application No. 10-2012-0099535 filed on Sep. 7, 2012, the entire contents of which is incorporated herein for all purposes by this reference.

### BACKGROUND OF THE INVENTION

Field of the Invention

The present invention relates to a heat pump system for a vehicle and a method of controlling the same that simultaneously use a water heat source and an air heat source and that improve a heating performance and a dehumidification performance using a waste heat occurring in a motor and an electrical equipment.

Description of Related Art

In general, an air-conditioning apparatus for a vehicle includes an air conditioner module for heating and air conditioning indoors of the vehicle.

In such an air conditioner module, a heat exchange medium that is ejected by driving of a compressor circulates again to the compressor via a condenser, a receiver drier, an expansion valve, and an evaporator. In this process, the air conditioner module air-conditions indoors of the vehicle by heat exchange by the evaporator or heats indoors of the vehicle by exchanging a heat by injecting high temperature coolant into a heater.

An environmentally-friendly vehicle is generally classified into an electric vehicle that drives using a fuel cell or electricity as a power source and a hybrid vehicle that drives using engine and an electric battery.

In such environmentally-friendly vehicles, the electric vehicle includes a heat pump system.

In the electric vehicle, in a heating mode, a gas refrigerant of a high temperature and a high pressure flows to an indoor condenser through a valve and exchanges a heat with inhaled outdoor air, and outdoor air in which a heat is exchanged is injected into indoors of the vehicle while passing through a positive temperature coefficient (PTC) heater, thereby raising a temperature of vehicle indoors.

However, as described above, as a structure of a compressor, a heat exchanger, and each constituent element becomes complicated, there is a problem that entire system package becomes complicated.

Further, as surface freezing occurs at an external condenser at a winter season, heat exchange efficiency, a heating performance, and efficiency of a heat exchange medium are deteriorated, and when an air conditioning mode is converted to a heating mode, humidity increases by condensation water remaining at the outside of an evaporator, and thus windowpanes of the vehicle are steamed up.

In a defrost mode that removes surface freezing of an external condenser in order to prevent this problem, operation of a compressor is stopped and heating should be performed with only a PTC heater, and thus while a heating performance is extremely deteriorated, when a heating load increases according to increase of a power use amount and the vehicle drives while heating, there is a problem that a travel distance is shortened.

Further, when an outdoor temperature is low, a heating performance is remarkably low and a system is unstable, and when a liquid refrigerant is injected into the compressor, durability of the compressor is deteriorated.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a heat pump system for a vehicle and a method of controlling the same having advantages of simultaneously using a water heat source and an air heat source, improving a heating performance and a dehumidification performance using a waste heat occurring in a motor and an electrical equipment, and preventing external frost of an external condenser in an ultra low temperature.

The present invention has been made in an effort to further provide a heat pump system for a vehicle and a method of controlling the same having advantages of increasing an entire travel distance of the vehicle with the same power by reducing a heating load that may occur in a heating mode of the vehicle.

In an aspect of the present invention, a heat pump system for a vehicle, may include a cooling apparatus that supplies and circulates coolant to a motor and an electrical equipment through a cooling line, wherein the cooling apparatus may include a radiator that cools the supplied coolant through heat exchange with outdoor air, a cooling fan that ventilates wind to the radiator, and a water pump that is connected to the cooling line and circulates the coolant along the cooling line, and an air conditioner apparatus that is connected through a refrigerant line in order to adjust heating and air conditioning of vehicle indoors, wherein the air conditioner apparatus may include a water-cooled condenser that is connected to the cooling line to change a temperature of the coolant using a waste heat that may have occurred in the motor and the electrical equipment according to each mode of the vehicle and that is connected to the refrigerant line to enable an injected refrigerant in the refrigerant line to exchange a heat with the coolant at the inside thereof, and an air-cooled condenser that is connected in series to the water-cooled condenser through the refrigerant line and that enables a refrigerant that is injected into the inside thereof to exchange a heat with the outdoor air.

The air conditioner apparatus may include a heating, ventilation, and air conditioning (HVAC) module having a switch door that selectively adjusts opening at the inside thereof in order to inject outdoor air having passed through an evaporator according to a heating mode, an air conditioning mode, and a dehumidification mode into an internal condenser and a positive temperature coefficient (PTC) heater, a compressor that is connected to the evaporator through the refrigerant line and that compresses a refrigerant of a gas state, an accumulator that is provided on the refrigerant line between the compressor and the evaporator and that supplies a gas refrigerant to the compressor, a first valve that selectively supplies a refrigerant that is exhausted from the compressor to the water-cooled condenser or the internal condenser according to a mode of the vehicle, a first expansion valve that receives and expands a refrigerant having passed through the internal condenser, a second valve that enables a refrigerant that is expanded through the first expansion valve to sequentially pass through the water-cooled condenser and the air-cooled condenser and that selectively supplies the refrigerant to the evaporator or the accumulator, and a second expansion valve that is provided between the evaporator and the second valve and that expands a refrigerant that is injected through switch of the second valve.

A pressure sensor is mounted on a refrigerant line that connects the compressor and the first valve.

The first and second, and three valves are formed with a 3-way valve.

The cooling apparatus and the air conditioner apparatus are operated by a control signal of a controller.

The cooling apparatus may further include a branch line that is installed on the cooling line between the water pump and the radiator and that bypasses the cooling line in order to directly supply coolant that is supplied from the water pump to the water-cooled condenser according to a heating mode, an air conditioning mode, and a dehumidification mode of the vehicle, and a third valve that selectively connects the cooling line and the branch line.

The third valve is formed with a 3-way valve.

The air-cooled condenser may have a plurality of switch films that selectively inject outdoor air at the front thereof.

The switch film operates by a control signal of a controller, is closed in a heating mode, and is opened in an air conditioning mode and a dehumidification mode.

In another aspect of the present invention, a method of controlling a heat pump system for a vehicle having a cooling apparatus that is electrically connected to a controller and that is fluid-connected through a cooling line and that may include a radiator, a water pump, and an electrical equipment, and an air conditioner apparatus that is connected through a refrigerant line and that may include a heating, ventilation, and air conditioning (HVAC) module that is formed with a plurality of valves, an expansion valve, a compressor, an accumulator, an evaporator, an internal condenser, a positive temperature coefficient (PTC) heater, and a switch door, may include operating the heat pump system, in a heating mode, an air conditioning mode, and a dehumidification mode according to a user's selection, wherein the heat pump system may include a water-cooled condenser that is connected to the cooling line and the refrigerant line and an air-cooled condenser that is disposed at the front of the radiator and connected to the refrigerant line, and changing a moving path of a refrigerant that circulates the air conditioner apparatus based on the heating mode, the air conditioning mode, and the dehumidification mode according to the user's selection, through operation of the each valve, such that a switch door of the HVAC module is selectively open and closed.

In the heating mode, by the cooling apparatus, raising a temperature of coolant that is injected into the water-cooled condenser through a waste heat that may have occurred in the motor and the electrical equipment, enabling the coolant to exchange a heat with a refrigerant that is injected into the water-cooled condenser through the refrigerant line, injecting the refrigerant having passed through the water-cooled condenser into the air-cooled condenser, and enabling the refrigerant to exchange a heat with a heat source of outdoor air, and in the heating mode, by the air conditioner apparatus, enabling a heated refrigerant through heat exchange with coolant and outdoor air in the water-cooled condenser and the air-cooled condenser, supplying the refrigerant to the internal condenser of the HVAC module through operation of the first valve in a state that is compressed with a gas refrigerant of a high temperature and high pressure state by passing through the accumulator and the compressor along a refrigerant line through opening of the second valve, sequentially supplying and circulating the refrigerant having passed through the internal condenser to the water-cooled condenser and the air-cooled condenser in a state that is expanded through the first expansion valve, and opening the switch door so that outdoor air, having passed through the evaporator of the HVAC module from the outside passes through the internal condenser, and enabling the injected outdoor air to heat vehicle indoors together with a selective operation of the PTC heater while passing through the internal condenser.

In the air conditioning mode, cooling coolant that is injected into the radiator together with outdoor air by a cooling fan, and by the cooling apparatus lowering a temperature of a refrigerant by second heat exchange with outdoor air by injecting a refrigerant that may have exchanged a heat with coolant while passing through the water-cooled condenser into the air-cooled condenser while cooling the electrical equipment and the motor by circulating the coolant along the cooling line in a state that is cooled through heat exchange with a refrigerant that is injected into the water-cooled condenser, and by the air conditioner apparatus supplying an expanded refrigerant to the evaporator by operating the second valve so that a refrigerant of a low temperature that is cooled while passing through the air-cooled condenser injects into the second expansion valve that is connected to the evaporator of the HVAC module, exhausting the refrigerant that is evaporated through heat exchange with outdoor air in the evaporator, opening a refrigerant line that is connected to the water-cooled condenser through operation of the first valve and circulates the refrigerant in a state that is compressed while passing through the accumulator and the compressor, and cooling the vehicle indoors by closing the switch door so that outdoor air that is cooled while passing through the evaporator by a refrigerant that is injected into the evaporator is not injected into the internal condenser and by directly injecting outdoor air that is cooled while passing through the evaporator into the vehicle.

In the air conditioning mode, when the vehicle travels, opening each switch film that is installed at a front surface of the radiator to inject traveling wind into the radiator.

In the dehumidification mode, as a cooling fan operates, in a state in which coolant that is injected into the radiator together with outdoor air is cooled, by the cooling apparatus, cooling the motor and the electrical equipment through operation of the water pump with cooled coolant while lowering a temperature of a refrigerant and coolant by heat exchange of the refrigerant and the coolant of a low temperature that is injected into the water-cooled condenser, by the air conditioner apparatus, opening the second valve so that a refrigerant of a low temperature that is cooled while exchanging a heat with coolant and outdoor air while sequentially passing through the water-cooled condenser and the air-cooled condenser is injected into the second expansion valve that is connected to the evaporator of the HVAC module, supplying the expanded refrigerant to the evaporator, supplying a refrigerant to the internal condenser by opening a refrigerant line that is connected to the internal condenser through operation of the first valve in a compressed state while passing through the accumulator and the compressor by exhausting a refrigerant that is evaporated through heat exchange with outdoor air in the evaporator, supplying and circulating the refrigerant having passed through the internal condenser to the water-cooled condenser in a state that is expanded through the first expansion valve, opening the switch door so that outdoor air that is cooled while passing through the evaporator of the HVAC module from the outside passes through the internal condenser, and enabling injected outdoor air to dehumidify vehicle indoors while passing through the internal condenser and the PTC heater.

In the dehumidification mode, adjusting, by the controller, an expansion amount of the refrigerant through adjustment of opening of the first and second expansion valves.

In the dehumidification mode, when the vehicle travels, opening each switch film that is installed at a front surface of the radiator to inject traveling wind into the radiator.

In the heating mode, the air conditioning mode, and the dehumidification mode, controlling, by the controller, a wind amount of the cooling fan and a flux of the water pump according to a temperature state of a waste heat that may have occurred in the electrical equipment and a temperature state of the coolant and the refrigerant.

As described above, in a heat pump system for a vehicle and a method of controlling the same according to an exemplary embodiment of the present invention, the vehicle heat pump system includes a water-cooled condenser using coolant as a heat exchange medium and an air-cooled condenser using an air heat source, makes a refrigerant to flow in series, and uses a waste heat source occurring in a motor and an electrical equipment and a heat source of outdoor air, thereby improving an entire heating performance, efficiency, and a dehumidification performance and preventing external frost of the air-cooled condenser in an ultra low temperature.

Further, as a user operates a heating mode by using a waste heat source without operation of a PTC heater or by using together a waste heat source and a PTC heater according to a peripheral environment of the vehicle, there is a merit that an entire travel distance of the vehicle increases with the same power by reducing a heating load while a power use amount is prevented from increasing, and an entire market value of the heat pump system can be improved.

In an air conditioning mode of the vehicle, in a low speed driving condition, in IDLE and low speed driving conditions, which is a condition in which an electric heat amount of a motor and an electrical equipment is small, but that has a large air conditioner electric heat amount, a temperature of coolant that is injected into a water-cooled condenser is lowered, and by increasing a refrigerant condensation amount through simultaneous application of the water-cooled condenser and the air-cooled condenser, an air conditioning performance can be improved.

In a dehumidification mode, by reducing a frequent valve switch operation through application of a 3-way valve, occurrence of noise and a vibration can be reduced due to a valve switch operation, and because a dehumidification mode can continuously use in intermediate temperature and much moisture conditions, a remaining amount of condensation water reduces according to decrease of indoor humidity, and thus a moisture occurrence condition can be reduced.

Further, by together using outdoor air and coolant as a heat exchange medium of condensers, while a structure of each constituent element is simplified, a motor and an electrical equipment can be cooled with one radiator, and entire system package can be reduced and efficiency of a radiator can be improved through reduction of ventilation resistance.

Further, by exchanging a heat of coolant and a refrigerant using a waste heat that has occurred in a motor and an electrical equipment in a water-cooled condenser, a heat exchange performance can be previously prevented from being deteriorated by external freezing that has occurred when a conventional air-cooled condenser is individually applied in an ultra low temperature condition, and even if a separate defrost mode does not exist, external frost of an air-cooled condenser can be prevented.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram illustrating a heat pump system for a vehicle according to various exemplary embodiments of the present invention.

FIG. 2 is a diagram illustrating a heating mode operation state of a heat pump system for a vehicle according to various exemplary embodiments of the present invention.

FIG. 3 is a diagram illustrating an air conditioning mode operation state of a heat pump system for a vehicle according to various exemplary embodiments of the present invention.

FIG. 4 is a diagram illustrating a dehumidification mode operation state of a heat pump system for a vehicle according to various exemplary embodiments of the present invention.

FIG. 5 is a block diagram illustrating a heat pump system for a vehicle according to various exemplary embodiments of the present invention.

FIG. 6 is a block diagram illustrating a heat pump system for a vehicle according to various exemplary embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

Before a description, an exemplary embodiment that is described in this specification and a configuration that is shown in the drawings are only an exemplary embodiment of the present invention and do not represent the entire spirit and scope of the invention and thus it should be understood that various modifications and exemplary variations that can replace the exemplary embodiment and the configuration may exist at an application time point of the present invention.

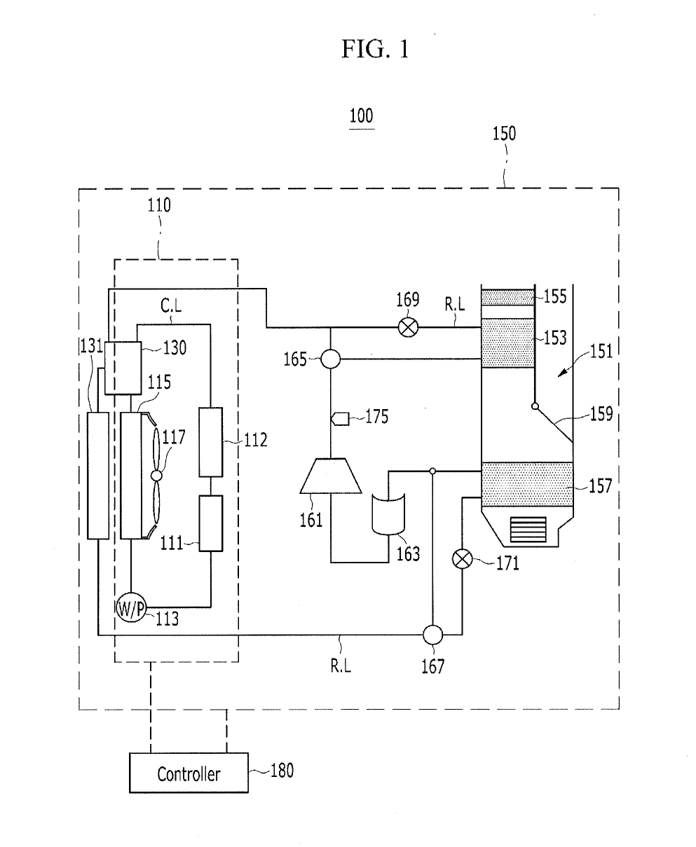

FIG. 1 is a block diagram illustrating a heat pump system for a vehicle according to a first exemplary embodiment of the present invention.

Referring to FIG. 1, in a vehicle heat pump system 100 and a method of controlling the same according to an exemplary embodiment of the present invention, the vehicle heat pump system 100 has a structure that can simultaneously use a water heat source and an air heat source, improve a heating performance and a dehumidification performance using a waste heat occurring in a motor 111 and an electrical equipment 112, and prevent external frost of an external condenser in an ultra low temperature.

Further, the vehicle heat pump system 100 has a structure that can increase an entire travel distance of the vehicle with the same power by reducing a heating load that may occur in a heating mode of the vehicle.

For this purpose, as shown in FIG. 1, the vehicle heat pump system 100 according to an exemplary embodiment of the present invention includes a cooling apparatus 110 that supplies coolant to a motor 111, an electrical equipment 112, and an engine and circulates the coolant through a cooling line (hereinafter, referred to as a ‘C.L’) in which coolant flows and an air conditioner apparatus 150 that is connected through a refrigerant line (hereinafter, referred to as an ‘R.L’) in which a refrigerant flows in order to adjust heating and air conditioning of vehicle indoors.

In the present exemplary embodiment, the cooling apparatus 110 includes a radiator 115 that is provided at the front of the vehicle and that circulates coolant along the C.L through operation of a water pump 113 and that cools the supplied coolant through a heat exchange with outdoor air and a cooling fan 117 that is mounted at the rear of the radiator 115 to ventilate wind to the radiator 115.

The heat pump system 100 according to the present exemplary embodiment further includes a water-cooled condenser 130 to which the C.L and the R.L are each connected and an air-cooled condenser 131 that is connected to the water-cooled condenser 130 through the R.L.

First, the water-cooled condenser 130 is connected to the C.L to change a temperature of coolant using a waste heat occurring in the motor 111 and the electrical equipment 112 according to each mode of the vehicle, and the water-cooled condenser 130 is connected to the R.L to enable an injected refrigerant to exchange a heat with the coolant at the inside thereof.

Here, the water-cooled condenser 130 has a temperature sensor at the inside thereof, and the temperature sensor senses a water temperature of injected coolant and a temperature of a refrigerant.

In the present exemplary embodiment, the water-cooled condenser 130 is separately provided from the radiator 115 to be connected through the C. L, but the present invention is not limited thereto and the water-cooled condenser 130 may be integrally formed at the inside of the radiator 115.

In the present exemplary embodiment, the air-cooled condenser 131 is coupled in series to the water-cooled condenser 130 through the R.L and is disposed at the front of the radiator 115 to enable a refrigerant that is injected into the inside to exchange a heat with outdoor air.

In the present exemplary embodiment, the air conditioner apparatus 150 includes a heating, ventilation, and air conditioning (HVAC) module 151, a compressor 161, an accumulator 163, first and second valves 165 and 167, and first and second expansion valves 169 and 171, and hereinafter, each constituent element will be described in detail.

First, in order to inject outdoor air, having passed through an evaporator 157 into an internal condenser 153 and a PTC heater 155 according to air conditioning, heating, and dehumidification modes, the HVAC module 151 has a switch door 159 that selectively adjusts opening at the inside thereof.

That is, the switch door 159 is opened to inject outdoor air, having passed through the evaporator 157 into the internal condenser 153 and the PTC heater 155 upon heating the vehicle and closes the internal condenser 153 and the PTC heater 155 in order to directly inject outdoor air that is cooled while passing through the evaporator 157 into the vehicle upon air conditioning.

In the present exemplary embodiment, the compressor 161 is connected to the evaporator 157 through the R.L and compresses a refrigerant of a gas state.

The accumulator 163 is provided on the R.L between the compressor 161 and the evaporator 157, stores a liquid refrigerant at the inside thereof in order to supply only a gas refrigerant to the compressor 161, vaporizes the stored liquid refrigerant, and supplies again a gas refrigerant to the compressor 161, thereby improving efficiency and durability of the compressor 161.

In the present exemplary embodiment, the first valve 165 selectively supplies a refrigerant that is exhausted from the compressor 161 to the internal condenser 153 according to a mode of the vehicle, and the first expansion valve 169 receives and expands a refrigerant, having passed through the internal condenser 153.

In the present exemplary embodiment, the first valve 165 selectively supplies a refrigerant that is exhausted from the compressor 161 to the water-cooled condenser 130 or the internal condenser 153 according to a mode of the vehicle.

The first expansion valve 169 receives and expands the refrigerant, having passed through the internal condenser 153 through the R.L.

Here, a pressure sensor 175 is mounted on the R.L between the compressor 161 and the first valve 165 and senses a pressure of a refrigerant that is exhausted in a state that is compressed by the compressor 161.

The second valve 167 enables a refrigerant that is expanded through the second expansion valve 171 to sequentially pass through the water-cooled condenser 130 and the air-cooled condenser 131 and selectively supplies the refrigerant to the evaporator 157 or the accumulator 163.

The second expansion valve 171 is provided between the evaporator 157 and the second valve 167, expands a refrigerant that is injected through switch of the second valve 167, and supplies the refrigerant to the evaporator 157.

Here, the first valve 165 supplies a refrigerant to the water-cooled condenser 130 or the internal condenser 153, and the second valve 167 is preferably formed with a 3-way valve that selectively switches and connects the R.L in order to supply the refrigerant to the accumulator 163 or the second expansion valve 171.

The cooling apparatus 110 and the air conditioner apparatus 150 having the above-described configuration are each connected to a controller 180 and operate by a control signal of the controller 180.

That is, the controller 180 controls the cooling fan 117 of the cooling apparatus 110 and the water pump 113 according to a heating mode, an air conditioning mode, and a dehumidification mode of the vehicle by a user's selection and a signal that is output from a temperature sensor of the condenser 130.

Further, while controlling a switch operation of the switch door 159 of the HVAC module 151 in the air conditioner apparatus 150 according to a mode of the vehicle, the controller 180 controls a switch operation of the first and second valves 165 and 167 and controls an expansion amount of a refrigerant by controlling the first and second expansion valves 169 and 171.

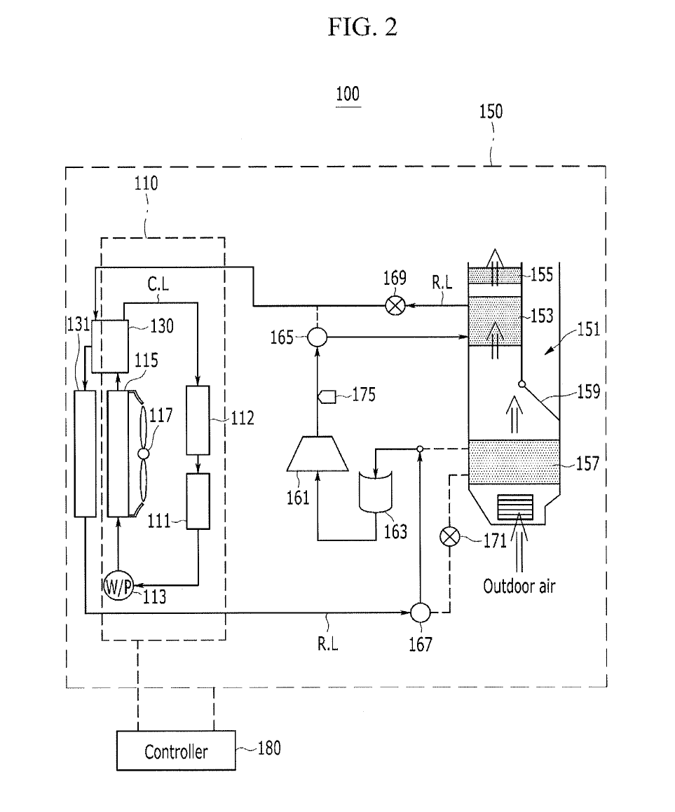

Hereinafter, operation of a vehicle heater pump system and a method of controlling the vehicle heater pump system having the above-described configuration according to an exemplary embodiment of the present invention will be described in detail with reference to FIGS. 2 to 4.

FIGS. 2 to 4 are diagrams illustrating an operation state in a heating mode, an air conditioning mode, and a dehumidification mode of a heat pump system for a vehicle according to a first exemplary embodiment of the present invention.

First, a method of controlling a heat pump system for a vehicle according to a first exemplary embodiment of the present invention is applied to the heat pump system 100 including the cooling apparatus 110 that is connected to the controller 180 and that is connected through the C.L and that includes the radiator 115, the water pump 113, the motor 111, and the electrical equipment 112 and the air conditioner apparatus 150 that is connected through the R.L and that includes the HVAC module 151 that is formed with the plurality of valves 165 and 167, the expansion valves 169 and 171, the compressor 161, the accumulator 163, the evaporator 157, the internal condenser 153, the PTC heater 155, and the switch door 159.

Here, as described above, the heat pump system 100 further includes the water-cooled condenser 130 that is connected to the C.L and the R.L and the air-cooled condenser 131 that is disposed at the front of the radiator 115 and that is coupled in series to the water-cooled condenser 130 through the R.L.

In the method of controlling the heat pump system 100, a moving path of a refrigerant that circulates the air conditioner apparatus 150 on a mode basis according to a user's selection is changed through operation of the valves 165 and 167, and the switch door 159 of the HVAC module 151 is selectively opened and closed.

That is, a heating mode, an air conditioning mode, and a dehumidification mode of the heat pump system 100 according to an exemplary embodiment of the present invention may be operated according to a user's selection or automatic adjustment.

First, in a heating mode of the heat pump system 100, operation of the heat pump system 100 and a method of controlling the heat pump system 100 will be described with reference to FIG. 2.

Referring to FIG. 2, in a heating mode, the cooling apparatus 110 raises a temperature of coolant that is injected into the water-cooled condenser 130 using a waste heat occurring in the motor 111 and the electrical equipment 112 and enables the coolant to exchange a heat with a refrigerant that is injected into the water-cooled condenser 130 through the R.L.

The refrigerant, having passed through the water-cooled condenser 130 is injected into the air-cooled condenser 131 and is condensed through heat exchange with outdoor air while passing through the air-cooled condenser 131.

In this case, as operation of the cooling fan 117 is stopped or as a wind velocity of the cooling fan 117 is deteriorated, cooling of coolant that is injected into the radiator 115 is delayed or prevented.

In such a state, the water-cooled condenser 130 raises a temperature of a refrigerant through heat exchange with the refrigerant that is injected through the R.L.

Here, the controller 180 determines a temperature of coolant and a refrigerant through a temperature sensor that is mounted in the water-cooled condenser 130, and controls a flux of the water pump 113 or a wind amount of the cooling fan 117 according to a temperature state of a waste heat that has occurred in the motor 111 and the electrical equipment 112, a temperature state of coolant, and a pressure state of a refrigerant.

The air conditioner apparatus 150 enables a refrigerant that is heated through heat exchange with coolant and outdoor air in the water-cooled condenser 130 and the air-cooled condenser 131, respectively to pass through the accumulator 163 and the compressor 161 along the R.L through opening of the second valve 167.

Accordingly, in a state that is compressed in a gas refrigerant of a high temperature and high pressure state while passing through the compressor 161, as the R.L that is connected to the internal condenser 153 is opened by the first valve 165, the refrigerant is supplied to the internal condenser 153.

Here, the pressure sensor 175 that is mounted on the R.L between the compressor 161 and the first valve 165 measures a pressure of a refrigerant that is exhausted from the compressor 161 and outputs a measured value thereof to the controller 180.

The controller 180 determines a pressure of a refrigerant according to the measured value that is output from the pressure sensor 175 and adjusts opening of the first valve 165 according to a requested vehicle state.

The refrigerant, having passed through the internal condenser 153 moves along the R.L in a state that is expanded through the first expansion valve 169, sequentially passes through the water-cooled condenser 130 and the air-cooled condenser 131, and circulates along the R.L through repetition of the above-described operation.

That is, in a heating mode, when a gas refrigerant of a high temperature and high pressure state is supplied to the internal condenser 153, the controller 180 opens the switch door 159 so that outdoor air, having passed through the evaporator 157 of the HVAC module 151 from the outside passes through the internal condenser 153.

Accordingly, when outdoor air that is injected from the outside passes through the evaporator 157 in which a refrigerant is not supplied, the outdoor air is injected in a room temperature state that is not cooled, is converted to a high temperature state while passing through the internal condenser 153, and is supplied into vehicle indoors together with a selective operation of the PTC heater 155, thereby heating vehicle indoors.

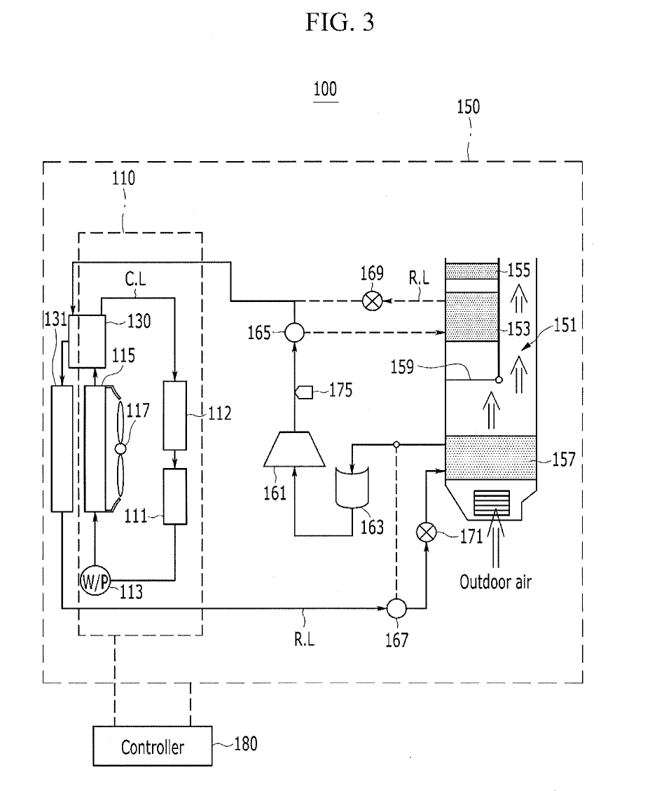

In the present exemplary embodiment, in an air conditioning mode of the heat pump system 100, operation of the heat pump system 100 and a method of controlling the heat pump system 100 will be described with reference to FIG. 3.

First, in an air conditioning mode, as shown in FIG. 3, as the cooling fan 117 operates by the controller 180, the cooling apparatus 110 cools coolant that is injected into the radiator 115 together with outdoor air.

In this case, the cooling fan 117 operates in a maximum speed to cool coolant, having passed through the radiator 115 to the maximum.

In such a state, the cooled coolant circulates along the C.L through operation of the water pump 113 and cools the motor 111 and the electrical equipment 112 in a state that is cooled through heat exchange with a refrigerant while passing through the water-cooled condenser 130.

In a state in which the refrigerant exchanges a heat with coolant while passing through the water-cooled condenser 130, the refrigerant is injected into the air-cooled condenser 131 to secondly exchange a heat with outdoor air and thus a temperature of the refrigerant is lowered, and the refrigerant is efficiently condensed.

Here, the controller 180 determines a temperature of coolant through a temperature sensor that is mounted in the water-cooled condenser 130 and controls a flux of the water pump 113 or a wind amount of the cooling fan 117 according to a temperature state of a waste heat occurring in the motor 111 and the electrical equipment 112 and a temperature state of coolant.

The controller 180 opens the R.L by operating the second valve 167 so that a refrigerant of a low temperature that is cooled while passing through the air-cooled condenser 131 in the air conditioner apparatus 150 is injected into the second expansion valve 171 that is connected to the evaporator 157 of the HVAC module 151.

The refrigerant of a low temperature that is injected into the second expansion valve 171 is supplied to the evaporator 157 along the R.L in an expanded state.

Thereafter, the refrigerant is evaporated through heat exchange with outdoor air in the evaporator 157 and is compressed while passing through the accumulator 163 and the compressor 161 along the R.L.

While the refrigerant, having compressed through the above-described operation repeats the above-described operation through opening of the R.L that is connected again to the water-cooled condenser 130 through operation of the first valve 165, the refrigerant circulates along the R.L.

Here, outdoor air that is injected into the HVAC module 151 is cooled while passing through the evaporator 157 by the refrigerant of a low temperature state that is injected into the evaporator 157.

In this case, the switch door 159 closes a passing portion toward the internal condenser 153 so that the cooled outdoor air does not pass through the internal condenser 153 and the PTC heater 155 and directly injects the cooled outdoor air into the vehicle, thereby performing air conditioning.

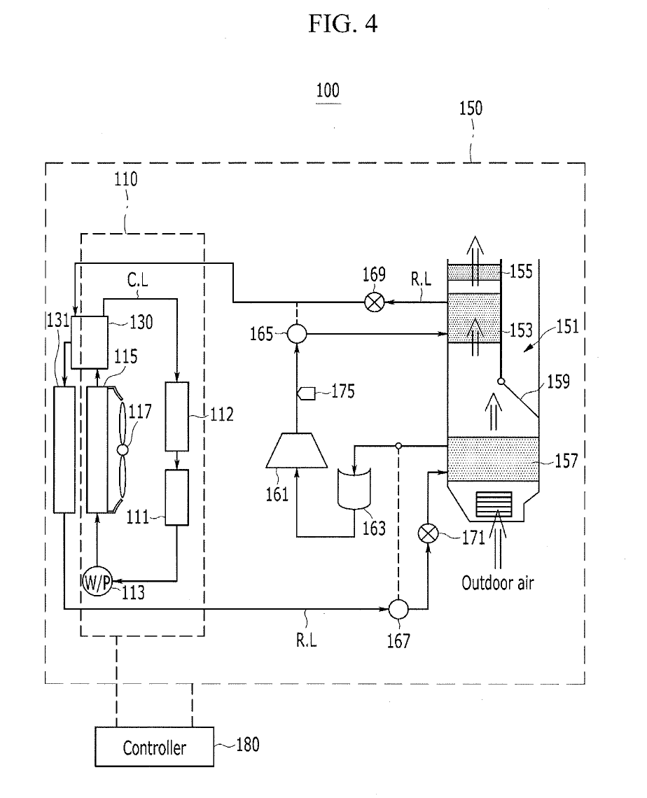

In a dehumidification mode of the heat pump system 100, operation of the heat pump system 100 and a method of controlling the heat pump system 100 will be described with reference to FIG. 4.

First, in the dehumidification mode, as shown in FIG. 4, as the cooling fan 117 operates by the controller 180, the cooling apparatus 110 cools coolant that is injected into the radiator 115 together with outdoor air.

In such a state, the cooled coolant is injected into the water-cooled condenser 130 through operation of the water pump 113, and is circulated along the C.L in a state having a lowered temperature through heat exchange with a refrigerant, thereby cooling the motor 111 and the electrical equipment 112.

Here, the controller 180 determines a temperature of coolant and a refrigerant through a temperature sensor that is mounted in the water-cooled condenser 130 and controls a flux the water pump 113 or a wind amount of the cooling fan 117 according to a temperature state of a waste heat that has occurred in the motor 111 and the electrical equipment 112, a temperature state of coolant, and a pressure state of the refrigerant.

In order to inject a refrigerant of a low temperature that is cooled through heat exchange with coolant of a low temperature state and outdoor air into the second expansion valve 171 that is connected to the evaporator 157 of the HVAC module 151 while sequentially passing through the water-cooled condenser 130 and the air-cooled condenser 131, the air conditioner apparatus 150 opens the R.L through operation of the second valve 167.

Thereafter, the refrigerant of a low temperature that is injected into the second expansion valve 171 is supplied to the evaporator 157 along the R.L in an expanded state.

Thereafter, the refrigerant is evaporated through heat exchange with outdoor air in the evaporator 157 and is compressed to a gas refrigerant of a high temperature high pressure state while passing through the accumulator 163 and the compressor 161 along the R.L.

As the R.L that is connected to the internal condenser 153 is opened by the first valve 165, the compressed gas refrigerant is supplied to the internal condenser 153.

Here, the pressure sensor 175 that is mounted on the R.L between the compressor 161 and the first valve 165 measures a pressure of a refrigerant that is exhausted from the compressor 161 and outputs a measured value thereof to the controller 180.

The controller 180 determines a pressure of the refrigerant according to the measured value that is output from the pressure sensor 175 and adjusts opening of the first valve 165 according to a requested vehicle state.

The refrigerant, having passed through the internal condenser 153 passes through the water-cooled condenser 130 along the R.L that is connected to the water-cooled condenser 130 and is injected into the air-cooled condenser 131 in a state that is expanded through the first expansion valve 169, and circulates along the R.L while repeating the above-described operation.

In this case, the controller 180 adjusts an expansion amount of a refrigerant through adjustment of opening of the first and second expansion valves 169 and 171.

Here, outdoor air that is injected into the HVAC module 151 is cooled while passing through the evaporator 157 by the refrigerant of a low temperature state that is injected into the evaporator 157.

In this case, the switch door 159 opens a portion that is connected to the internal condenser 153 so that the cooled outdoor air passes through the internal condenser 153, and the injected outdoor air is dehumidified while passing through the evaporator 157, is heated through the internal condenser 153, and is injected into the vehicle, thereby dehumidifying indoors of the vehicle.

When describing a method of controlling a heat pump system for a vehicle according to an exemplary embodiment of the present invention, in the heating mode, the PTC heater 155 operates together with outdoor air, but the present invention is not limited thereto and operation of the PTC heater 155 is selected and embodied by setting of a heating temperature according to a user's selection.

Accordingly, a heating mode may includes a quick heating mode that operates together with the PTC heater 155 or a general heating mode that performs heating with only outdoor air, having passed through the internal condenser 153 without operation of the PTC heater 155.

Therefore, as described above, when the vehicle heat pump system 100 and a method of controlling the same according to an exemplary embodiment of the present invention is applied, the vehicle heat pump system 100 includes the water-cooled condenser 130 using coolant as a heat exchange medium and the air-cooled condenser 131 using an air heat source, makes a refrigerant to flow in series and uses a waste heat source occurring in the motor 111 and the electrical equipment 112 and a heat source of outdoor air, thereby improving an entire heating performance, efficiency, and a dehumidification performance and preventing external frost of the air-cooled condenser 131 that is disposed at the outside in an ultra low temperature.

Further, as a user operates a heating mode by using a waste heat without operation of the PTC heater 155 or by using together a waste heat and the PTC heater 155 according to a peripheral environment of the vehicle, a power use amount is prevented from increasing, and by simultaneously reducing a heating load, there is a merit that an entire travel distance of the vehicle increases with the same power and an entire market value of the heat pump system can be improved.

In an air conditioning mode of the vehicle, in a low driving condition, an electric heat amount of the motor 111 and the electrical equipment 112 is small, but in IDLE and low speed driving conditions, which is a condition having a large air conditioner electric heat amount, a temperature of coolant that is injected into the water-cooled condenser is lowered, and by increasing a refrigerant condensation amount through simultaneous application of the water-cooled condenser 130 and the air-cooled condenser 131, an air conditioning performance can be improved.

In a dehumidification mode, by reducing a frequent valve switch operation through application of a 3-way valve, occurrence of noise and a vibration due to a valve switch operation can be reduced, and in intermediate temperature and much moisture conditions, because a dehumidification mode can be continuously used, the remaining amount of condensation water according to decrease of indoor humidity is reduced and thus a condition in which moisture occurs can be reduced.

Further, by using together outdoor air and coolant as a heat exchange medium of the condensers 130 and 131, while a structure of each constituent element is simplified, the motor 111 and the electrical equipment 112 can be cooled with one radiator 115, and entire system package can be reduced and efficiency of the radiator can be improved through reduction of ventilation resistance.

Further, in the water-cooled condenser 130, by performing heat exchange of coolant and a refrigerant using a waste heat that has occurred in the motor 111 and the electrical equipment 112, a heat exchange performance can be previously prevented from being deteriorated according to external frost that has occurred when individually applying a conventional air-cooled condenser in an ultra low temperature condition, and external frost of the air-cooled condenser 131 can be prevented without a separate defrost mode.

When describing a heat pump system for a vehicle and a method of controlling the same according to an exemplary embodiment of the present invention, the vehicle heat pump system includes the first and second valves 165 and 167, but the present invention is not limited thereto and by applying a separate 2-way valve on a cooling line and a refrigerant line, a working fluid may be bypassed or a flux of a working fluid may be adjusted.

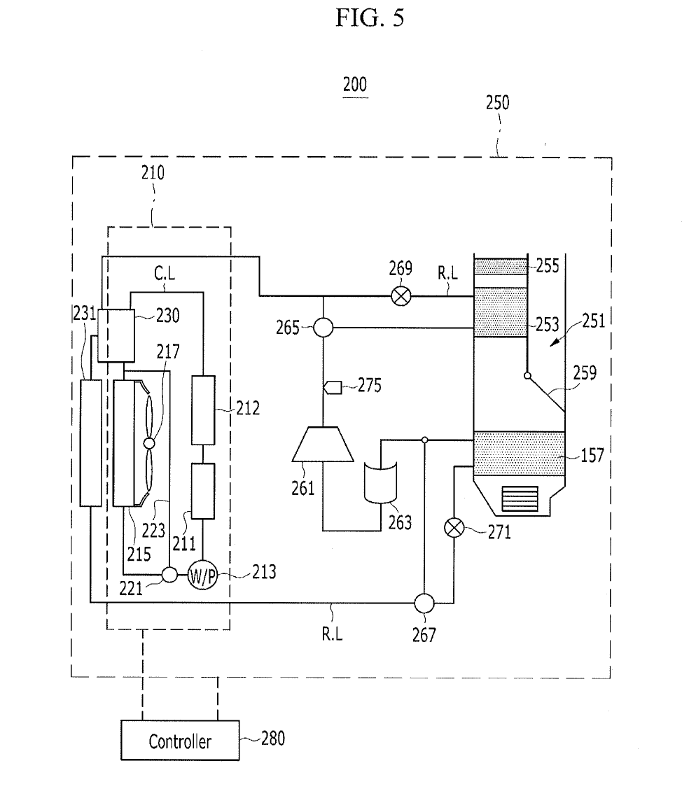

FIG. 5 is a block diagram illustrating a heat pump system for a vehicle according to a second exemplary embodiment of the present invention.

Referring to FIG. 5, a vehicle heat pump system 200 according to a second exemplary embodiment of the present invention includes a cooling apparatus 210 that supplies and circulates coolant to a motor 211, an electrical equipment 212, and a non-illustrated engine through a C.L in which coolant flows and an air conditioner apparatus 250 that is connected through an R.L in which coolant flows to adjust heating and air conditioning of vehicle indoors.

In the present exemplary embodiment, the cooling apparatus 210 includes a radiator 215 that is provided at the front of the vehicle to circulate coolant along the C.L through operation of a water pump 213 and that cools the supplied coolant through heat exchange with outdoor air and a cooling fan 217 that is mounted at the rear of the radiator 215 to ventilate wind to the radiator 215.

The heat pump system 200 according to a second exemplary embodiment of the present invention further includes a water-cooled condenser 230 to which the C.L and the R.L are each connected and an air-cooled condenser 231 that is connected to the water-cooled condenser 230 through the R.L.

First, the water-cooled condenser 230 is connected to the C.L to change a temperature of coolant using a waste heat occurring in the motor 211 and the electrical equipment 212 according each mode of the vehicle, and the water-cooled condenser 230 is connected to the R.L to enable an injected refrigerant to exchange a heat with coolant at the inside thereof.

Here, the water-cooled condenser 230 has a temperature sensor at the inside thereof, and the temperature sensor senses a water temperature of injected coolant and a temperature of a refrigerant.

In a second exemplary embodiment of the present invention, the air-cooled condenser 231 is coupled in series to the water-cooled condenser 230 through the R.L, and the air-cooled condenser 231 is disposed at the front of the radiator 215 to enable a refrigerant that is injected into the inside thereof coolant to exchange a heat with outdoor air.

Here, the cooling apparatus 210 according to a second exemplary embodiment of the present invention further includes a branch line 223 and a third valve 221.

First, the branch line 223 is installed on the C.L between the water pump 213 and the radiator 215 and bypasses the C.L in order to directly supply coolant that is supplied from the water pump 213 to the water-cooled condenser 130 according to a heating mode, an air conditioning mode, and a dehumidification mode of the vehicle.

The third valve 221 selectively connects the C.L and the branch line 223.

The third valve 221 is controlled by a controller 280, bypasses coolant through the branch line 223 without passing through the radiator 215 through a switch operation in a heating mode of the vehicle, directly supplies the coolant to the water-cooled condenser 230, and enables the coolant to pass through the motor 211 and the electrical equipment 212, thereby performing a function of raising a water temperature of the coolant by a waste heat.

In order to supply coolant to the radiator 215 or the water-cooled condenser 230, the third valve 221 is preferably a 3-way valve that selectively switches and connects the C.L and the branch line 223.

In a second exemplary embodiment of the present invention, the air conditioner apparatus 250 includes a heating, ventilation, and air conditioning (HVAC) module 251, a compressor 261, an accumulator 263, first and second valves 265 and 267, and first and second expansion valves 269 and 271.

The HVAC module 251 has a switch door 259 that selectively adjusts opening at the inside thereof in order to inject outdoor air, having passed through an evaporator 257 into an internal condenser 253 and a PTC heater 255 according to air conditioning, heating, and dehumidification modes.

The cooling apparatus 210 and the air conditioner apparatus 250 are connected to the controller 280 and each operate according to a control signal of the controller 280.

The air conditioner apparatus 250 having such a configuration is the same as that in the first exemplary embodiment of the present invention and therefore a detailed description thereof will be omitted.

Further, in a method of controlling a heat pump system according to a second exemplary embodiment of the present invention, in a heating mode, by circulating coolant to the motor 211, the electrical equipment 212, and the water-cooled condenser 230 along the C.L instead of injecting coolant into the radiator 215 through switch of the third valve 221, a temperature of coolant is more quickly rises through a heat exchange with a waste heat.

In a method of controlling a heat pump system according to a second exemplary embodiment of the present invention, in a heating mode in which the third valve 221 operates, only a coolant circulation path of the cooling apparatus 210 is changed and the method according to the second exemplary embodiment is the same as that of the first exemplary embodiment in operation and control of each constituent in an air conditioning mode and a dehumidification mode and thus a detailed description thereof will be omitted.

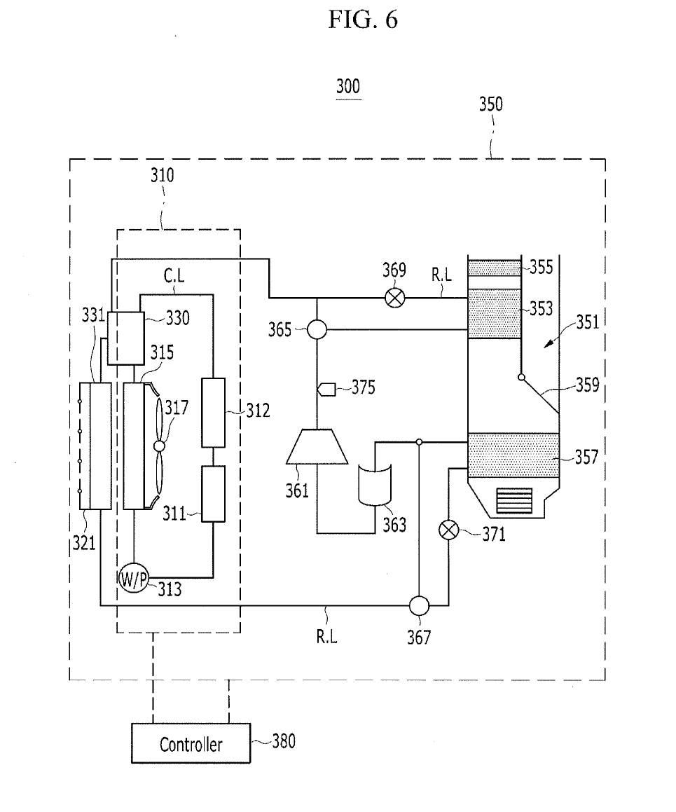

FIG. 6 is a block diagram illustrating a heat pump system for a vehicle according to a third exemplary embodiment of the present invention.

Referring to FIG. 6, a vehicle heat pump system 300 according to a third exemplary embodiment of the present invention includes a cooling apparatus 310 that supplies and circulates coolant to a motor 311, an electrical equipment 312 and a non-illustrated engine through a C.L in which coolant flows and an air conditioner apparatus 350 that is connected through an R.L in which a refrigerant flows to adjust heating and air conditioning of vehicle indoors.

In the present exemplary embodiment, the cooling apparatus 310 includes a radiator 315 that is provided at the front of the vehicle to circulate coolant along the C.L through operation of the water pump 313 and that cools the supplied coolant through heat exchange with outdoor air, and a cooling fan 317 that is mounted at the rear side of the radiator 315 to ventilate wind to the radiator 315.

The heat pump system 300 according to a second exemplary embodiment of the present invention further includes a water-cooled condenser 330 in which the C.L and the R.L are each connected and an air-cooled condenser 331 that is connected to the water-cooled condenser 330 through the R.L.

First, the water-cooled condenser 330 is connected to the C.L to change a temperature of coolant using a waste heat that has occurred in the motor 311 and the electrical equipment 312 according to each mode of the vehicle, and the water-cooled condenser 330 is connected to the R.L to enable an injected refrigerant to exchange a heat with coolant at the inside thereof.

Here, the water-cooled condenser 330 has a temperature sensor at the inside thereof, and the temperature sensor senses a water temperature of the injected coolant and a temperature of a refrigerant.

In a second exemplary embodiment of the present invention, the air-cooled condenser 331 is coupled in series to the water-cooled condenser 330 through the R.L and is disposed at the front of the radiator 315 to enable a refrigerant that is injected into the inside thereof to exchange a heat with outdoor air.

Here, the air-cooled condenser 331 has a plurality of switch films 321 that selectively inject traveling wind or outdoor air from the outside of the vehicle at the front thereof.

The each switch film 321 adjusts injection of outdoor air by opening or closing a front surface of the air-cooled condenser 331 according to a heating mode, an air conditioning mode, and a dehumidification mode of the vehicle according to a driver's selection, thereby adjusting a cooling performance of the air-cooled condenser 331.

That is, the switch film 321 operates by a control signal of a controller 380, is closed in a heating mode, and is opened in an air conditioning mode and a dehumidification mode.

In a third exemplary embodiment of the present invention, the air conditioner apparatus 350 includes a heating, ventilation, and air conditioning (HVAC) module 351, a compressor 361, an accumulator 363, first and second valves 365 and 367, and first and second expansion valves 369 and 371.

The HVAC module 351 has a switch door 359 that selectively adjusts opening to inject outdoor air, having passed through an evaporator 357 into an internal condenser 353 and a PTC heater 355 at the inside thereof according to air conditioning, heating, and dehumidification modes.

The cooling apparatus 310 and the air conditioner apparatus 350 are connected to the controller 380 and each operate according to a control signal of the controller 380.

The air conditioner apparatus 350 having such a configuration is the same as that in the first exemplary embodiment of the present invention and therefore a detailed description thereof will be omitted.

Further, in a method of controlling a heat pump system according to a third exemplary embodiment of the present invention, in a heating mode, the switch film 321 that is mounted at the front of the air-cooled condenser 331 is closed by a control signal of the controller 380 to prevent traveling wind from being injected into the radiator 315 and the air-cooled condenser 331.

Simultaneously, as the controller 380 stops operation of the cooling fan 317 or deteriorates a wind velocity thereof, cooling of coolant, having passed through the radiator 315 is prevented, and a refrigerant, having passed through the air-cooled condenser 331 exchanges a heat with outdoor air within an engine compartment, thereby using an air heat source.

Alternatively, in an air conditioning mode and a dehumidification mode, in order to inject traveling wind and outdoor air into the radiator 315 and the air-cooled condenser 331, the each switch film 321 is opened by a control signal of the controller 380, thereby increasing cooling efficiency of the radiator 315 and the air-cooled condenser 331.

Here, in a dehumidification mode, the switch film 321 may maintain or close an opened state according to an air conditioner pressure.

In a method of controlling a heat pump system according to a third exemplary embodiment of the present invention, only an open or close operation of the switch film 321 that is installed at the front of the air-cooled condenser 331 is different, and the method of the third exemplary embodiment is the same as operation and control of constituent elements in a heating mode, an air conditioning mode, and a dehumidification mode according to the first exemplary embodiment and thus a detailed description thereof will be omitted.

In the first, second, and third exemplary embodiments of the present invention, in the heat pump systems 100, 200, and 300, the motors 111, 211, and 311 and the electrical equipments 112, 212, and 312 are disposed in series to the water-cooled condenser 130, 230, and 330 in the cooling apparatus 110, 210, and 310, but the present invention is not limited thereto, the water-cooled condenser 130, 230, and 330 may be disposed in parallel to the motor 111, 211, and 311 and the electrical equipments 112, 212, and 312.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1-9. (canceled)

10. A method of controlling a heat pump system for a vehicle having a cooling apparatus that is electrically connected to a controller and that is fluid-connected through a cooling line and that includes a radiator, a water pump, and an electrical equipment, and an air conditioner apparatus that is connected through a refrigerant line and that includes a heating, ventilation, and air conditioning (HVAC) module that is formed with a plurality of valves, an expansion valve, a compressor, an accumulator, an evaporator, an internal condenser, a positive temperature coefficient (PTC) heater, and a switch door, the method comprising:
operating the heat pump system, in a heating mode, an air conditioning mode, and a dehumidification mode according to a user's selection,
wherein the heat pump system includes a water-cooled condenser that is connected to the cooling line and the refrigerant line and an air-cooled condenser that is disposed at the front of the radiator and connected to the refrigerant line, and
changing a moving path of a refrigerant that circulates the air conditioner apparatus based on the heating mode, the air conditioning mode, and the dehumidification mode according to the user's selection, through operation of the each valve, such that a switch door of the HVAC module is selectively open and closed.

11. The method of claim 10, wherein:
in the heating mode, by the cooling apparatus,
raising a temperature of coolant that is injected into the water-cooled condenser through a waste heat that has occurred in the motor and the electrical equipment;
enabling the coolant to exchange a heat with a refrigerant that is injected into the water-cooled condenser through the refrigerant line;
injecting the refrigerant having passed through the water-cooled condenser into the air-cooled condenser; and
enabling the refrigerant to exchange a heat with a heat source of outdoor air; and
in the heating mode, by the air conditioner apparatus,
enabling a heated refrigerant through heat exchange with coolant and outdoor air in the water-cooled condenser and the air-cooled condenser;
supplying the refrigerant to the internal condenser of the HVAC module through operation of the first valve in a state that is compressed with a gas refrigerant of a high temperature and high pressure state by passing through the accumulator and the compressor along a refrigerant line through opening of the second valve;
sequentially supplying and circulating the refrigerant having passed through the internal condenser to the water-cooled condenser and the air-cooled condenser in a state that is expanded through the first expansion valve; and
opening the switch door so that outdoor air, having passed through the evaporator of the HVAC module from the outside passes through the internal condenser; and
enabling the injected outdoor air to heat vehicle indoors together with a selective operation of the PTC heater while passing through the internal condenser.

12. The method of claim 10, wherein in the air conditioning mode,
cooling coolant that is injected into the radiator together with outdoor air by a cooling fan; and
by the cooling apparatus:
lowering a temperature of a refrigerant by second heat exchange with outdoor air by injecting a refrigerant that has exchanged a heat with coolant while passing through the water-cooled condenser into the air-cooled condenser while cooling the electrical equipment and the motor by circulating the coolant along the cooling line in a state that is cooled through heat exchange with a refrigerant that is injected into the water-cooled condenser, and
by the air conditioner apparatus:
supplying an expanded refrigerant to the evaporator by operating the second valve so that a refrigerant of a low temperature that is cooled while passing through the air-cooled condenser injects into the second expansion valve that is connected to the evaporator of the HVAC module;
exhausting the refrigerant that is evaporated through heat exchange with outdoor air in the evaporator;
opening a refrigerant line that is connected to the water-cooled condenser through operation of the first valve and circulates the refrigerant in a state that is compressed while passing through the accumulator and the compressor; and
cooling the vehicle indoors by closing the switch door so that outdoor air that is cooled while passing through the evaporator by a refrigerant that is injected into the evaporator is not injected into the internal condenser and by directly injecting outdoor air that is cooled while passing through the evaporator into the vehicle.

13. The method of claim 12, wherein in the air conditioning mode, when the vehicle travels, opening each switch film that is installed at a front surface of the radiator to inject traveling wind into the radiator.

14. The method of claim 10, wherein in the dehumidification mode, as a cooling fan operates, in a state in which coolant that is injected into the radiator together with outdoor air is cooled,
by the cooling apparatus,
cooling the motor and the electrical equipment through operation of the water pump with cooled coolant while lowering a temperature of a refrigerant and coolant by heat exchange of the refrigerant and the coolant of a low temperature that is injected into the water-cooled condenser;
by the air conditioner apparatus,
opening the second valve so that a refrigerant of a low temperature that is cooled while exchanging a heat with coolant and outdoor air while sequentially passing through the water-cooled condenser and the air-cooled condenser is injected into the second expansion valve that is connected to the evaporator of the HVAC module;
supplying the expanded refrigerant to the evaporator;
supplying a refrigerant to the internal condenser by opening a refrigerant line that is connected to the internal condenser through operation of the first valve in a compressed state while passing through the accumulator and the compressor by exhausting a refrigerant that is evaporated through heat exchange with outdoor air in the evaporator;
supplying and circulating the refrigerant having passed through the internal condenser to the water-cooled condenser in a state that is expanded through the first expansion valve;
opening the switch door so that outdoor air that is cooled while passing through the evaporator of the HVAC module from the outside passes through the internal condenser; and
enabling injected outdoor air to dehumidify vehicle indoors while passing through the internal condenser and the PTC heater.

15. The method of claim 14, wherein in the dehumidification mode, adjusting, by the controller, an expansion amount of the refrigerant through adjustment of opening of the first and second expansion valves.

16. The method of claim 14, wherein in the dehumidification mode, when the vehicle travels, opening each switch film that is installed at a front surface of the radiator to inject traveling wind into the radiator.

17. The method of claim 10, wherein in the heating mode, the air conditioning mode, and the dehumidification mode, controlling, by the controller, a wind amount of the cooling fan and a flux of the water pump according to a temperature state of a waste heat that has occurred in the electrical equipment and a temperature state of the coolant and the refrigerant.
